(19) United States
(12) Patent Application Publication
(10) Pub. No.: US 2023/0057196 A1
(43) Pub. Date: Feb. 23, 2023

(54) THERMAL IMAGE AUXILIARY PROCESSING DEVICE, POSITIONING DEVICE AND METHOD THEREOF

(71) Applicant: INDUSTRIAL TECHNOLOGY RESEARCH INSTITUTE, Hsinchu (TW)

(72) Inventors: Sheng-Yu CHUANG, Taichung City (TW); Hsin-Chang CHANG, Taichung City (TW); Chia-Sheng CHIANG, Taichung City (TW)

(73) Assignee: INDUSTRIAL TECHNOLOGY RESEARCH INSTITUTE, Hsinchu (TW)

(21) Appl. No.: 17/695,334

(22) Filed: Mar. 15, 2022

(30) Foreign Application Priority Data
Aug. 19, 2021 (TW) 110130622
Jan. 4, 2022 (CN) 202210001421.0

(51) Int. Cl. G01J 5/00; G01M 5/00; G06T 7/73; G06T 7/00; H04N 7/18

(52) U.S. Cl. CPC G01J 5/0066; G01J 5/0022; G01M 5/0033; G01M 5/0091; G06T 7/74; G06T 7/001; H04N 7/183; G01J 2005/0033; G01J 2005/0077; G06T 2207/30164; G06T 2207/10048

(57) ABSTRACT

A thermal image auxiliary processing method includes the following steps. A reference part is prepared. A reference positioning point or a reference positioning surface is established with the reference part. A cutting tool or a grinding tool is positioned with the reference positioning point or the reference positioning surface. According to a thermal image, a determined positioning point or a determined positioning surface is obtained. Through the above method, the present disclosure can be used for auxiliary positioning and wearing measurement of the cutting tool or the grinding tool, as well as for measuring the size, the angle or flatness of an object to be measured. Therefore, the present disclosure can avoid the problems of increased equipment downtime and realign errors caused by manual and visual measurement.

This application claims the benefits of Taiwan application Serial No. 110130622, filed Aug. 19, 2021 and People's Republic of China application Serial No. 202210001421.0, filed Jan. 4, 2022, the disclosures of which are incorporated by reference herein in its entirety.

### TECHNICAL FIELD

The disclosure relates in general to a processing method, and more particularly to a thermal image auxiliary processing device, a positioning device and a method thereof.

### BACKGROUND

Generally speaking, the tool positioning and wear detection, when the machine tool is processed, are mostly performed manually and visually. However, in such way, the feed length of the tool, the size of workpiece and the initial contact position of the object are measured and set first, it will result in increased downtime when the equipment is idle and a visual error in measurement. In addition, the tool must be removed from the machine and the workpiece are measured outside the machine, then the installed tool needs to be recalibrated in length and position due to the locking error of the machine. Moreover, even though the optical image recognition and measurement can be used, since the optical image recognition is easily affected by environmental factors such as light and surface materials, and requires a high-resolution camera, the requirements on image processing equipment, cost, and its technology are relatively high.

In addition, the traditional manual tool setting method is performed by the operator to move the tool, so that the tip of the tool gradually approaches the workpiece until the personnel's eyes can see the generation of cutting chips, then the coordinate of the tool is regarded as the axial direction of an aligned tool coordinate. However, the empirical error value of manual tool setting in this way is about over 10 μm, or even higher. Therefore, the error value may vary due to the eye condition and experience of the operator, or ambient light, etc.

### SUMMARY

The disclosure is related to a thermal image auxiliary processing device and a method thereof configured for auxiliary positioning of cutting tools or grinding tools before and after processing, wear detection and measurement of the size, angle or flatness of an object to be measured.

The disclosure is related to a thermal image auxiliary positioning device for alignment of cutting tools or grinding tools.

According to one embodiment of the present disclosure, a thermal image auxiliary processing method includes the following steps. Prepare a reference part. A reference positioning point or a reference positioning surface is established with the reference part. A cutting tool or a grinding tool is positioned with the reference positioning point or the reference positioning surface. According to a thermal image, a determined positioning point or a determined positioning surface is obtained.

According to one embodiment of the present disclosure, a thermal image auxiliary processing device is provided for positioning or measuring an object to be measured. The thermal image auxiliary processing device includes a thermal image sensing module and a processing unit. The thermal image sensing module synchronously monitors the thermal temperature rise of the object to be measured. The processing unit includes a controller. When the processing unit monitors at least one hot spot of temperature rise on the object to be measured according to the thermal image, the controller performs a mechanical coordinate conversion to obtain at least one position coordinate information.

According to one embodiment of the present disclosure, a thermal image auxiliary positioning device is provided for positioning a cutting tool or a grinding tool. The thermal image auxiliary positioning device includes a thermal image sensing module and a processing unit. The thermal image sensing module synchronously monitors the thermal temperature rise of the cutting tool or the grinding tool. According to a thermal image, when the processing unit monitors at least one hot spot of temperature rise on the cutting tool or the grinding tool, the processing unit sends a prompt signal.

### BRIEF DESCRIPTION OF THE DRAWINGS

FIG. 1A is a schematic diagram of a thermal image auxiliary processing device according to an embodiment of the present disclosure.

FIGS. 1B and 1C respectively are a flowchart of a thermal image auxiliary processing method according to an embodiment of the present disclosure.

FIG. 2 is a flowchart of a thermal image auxiliary processing method for tool positioning and wear detection according to an embodiment of the present disclosure.

FIGS. 3A and 3B are an example operation diagram of the thermal image auxiliary processing method for a tool (e.g., lathe tool) positioning in FIG. 2.

FIGS. 4A to 4D respectively are two example operation diagrams of the thermal image auxiliary processing method for a tool (e.g., lathe tool) wear detection in FIG. 2.

FIGS. 5A and 5B respectively are another example operation diagram of the thermal image auxiliary processing method for a tool (e.g., a drill or milling tool) positioning in FIG. 2.

FIGS. 6A to 6D are another two example operation diagrams of the thermal image auxiliary processing method for a tool (e.g., a milling tool) wear detection in FIG. 2.

FIGS. 7A to 7D are another two example operation diagrams of the thermal image auxiliary processing method for a tool (e.g., a drill or milling tool) wear detection in FIG. 2.

FIG. 8 is a flow chart of a thermal image auxiliary processing method for positioning and wear measurement of a grinding tool (e.g., grinding wheels) according to an embodiment of the present disclosure.

FIGS. 9A and 9B respectively are an example operation diagram of the thermal image auxiliary processing method for the positioning of a grinding tool (e.g., a grinding wheel) in FIG. 8.

FIGS. 10A and 10B respectively are another example operation diagram of the thermal image auxiliary processing method for the positioning of a grinding tool (e.g., a polygonal grinding wheel) in FIG. 8.

FIGS. 11A and 11B respectively are an example operation diagram of the thermal image auxiliary processing method for wear measurement of a grinding tool (e.g., grinding wheels) in FIG. 8.

FIGS. 12A and 12B are two example operation diagrams of the thermal image auxiliary processing method for angle measurement and planar measurement.

FIGS. 13A to 13D are exemplary operational diagrams of a thermal image auxiliary positioning method for alignment of a cutting tool or a grinding tool, respectively.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Exemplary embodiments will now be described more fully with reference to the accompanying drawings. However, the exemplary embodiments could be implemented in various forms, and should not be construed as being limited to the examples set forth herein; on the contrary, the description of these embodiments makes the present disclosure more comprehensive and complete, and fully conveys the concept of the exemplary embodiments to those skilled in the art. The described features, structures or characteristics could be combined in one or more embodiments in any suitable way.

In addition, the drawings are schematic illustrations of the present disclosure, and are not necessarily drawn to scale. The same reference numerals in the drawings denote the same or similar parts, and thus their repeated description will be omitted. Some of the block diagrams shown in the drawings are functional entities and do not necessarily correspond to physically or logically independent entities. These functional entities could be implemented in the form of software, or implemented in one or more hardware modules or integrated circuits, or implemented in different networks and/or processor devices and/or microcontroller devices.

It should be noted that, the embodiments of the present disclosure and features in different embodiments may be combined with each other if no conflict exists.

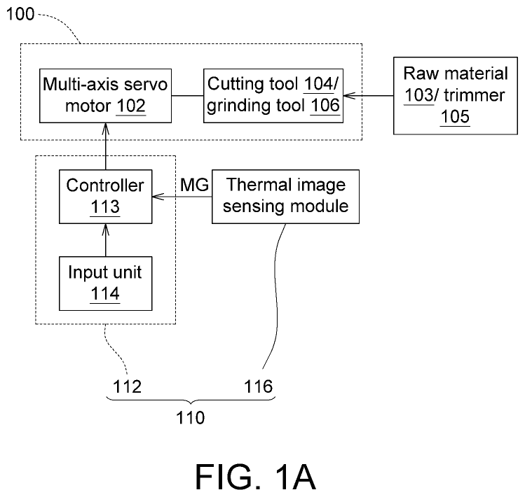

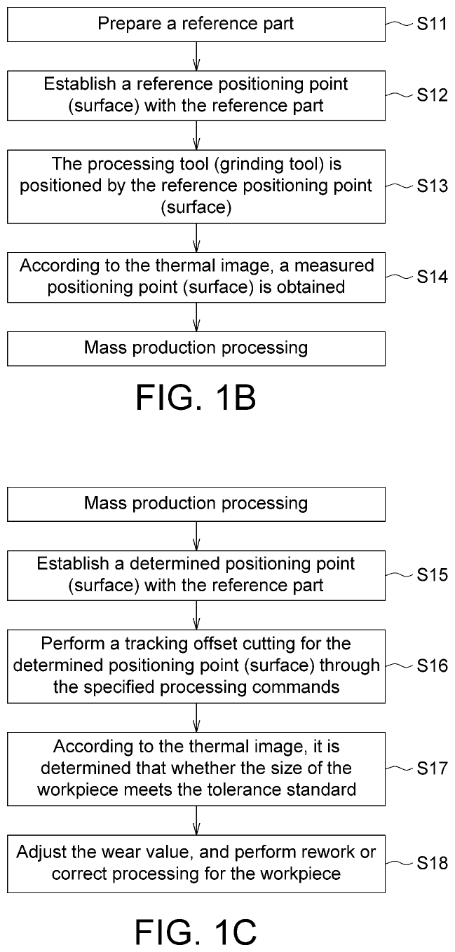

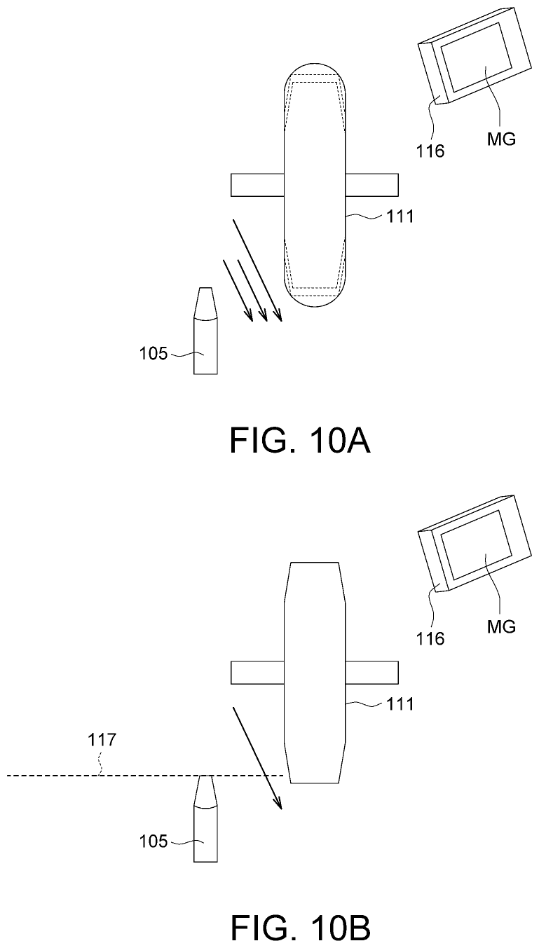

FIG. 1A shows a schematic diagram of a thermal image auxiliary processing device 110 for positioning and wear measurement of a cutting tool 104 or a grinding tool 106 according to an embodiment of the present disclosure, and FIGS. 1B and 10 respectively show a flow chart of a thermal image auxiliary processing method according to an embodiment of the present disclosure. In an embodiment, the thermal image auxiliary processing device 110 can be used in a machine tool 100, and the machine tool 100 includes a computer numerically controlled (CNC) machine tool such as a lathe, a milling machine, a drilling machine, or a grinding machine, which is configured to process a raw material (or workpiece) 103, such as cutting, milling, drilling or grinding process. The user can input commands to the multi-axis servo motor 102 of the machine tool 100 via the controller 113 to drive the cutting tool 104 or the grinding tool 106 and process the raw material 103 fixed on the machine to complete a finished product. Before or after the raw material 103 is processed, the user can also input commands to the multi-axis servo motor 102 of the machine tool 100 via the controller 113 to drive the reference part and position the raw material 103 fixed on the machine and perform tolerance measurement to ensure that the tolerance of the finished product after processing is within the allowable tolerance range. Alternatively, before the grinding tool 106 grinds the raw material 103, the user can use the tip of the trimmer 105 as a reference positioning point to trim the grinding surface, and after the grinding tool 106 grinds the raw material 103 for a period of time, the grinding tool 106 is then finely processed by the trimmer 105 and wear detection of the grinding tool 106 are performed to ensure that the tolerance of the finished product is within the allowable tolerance range.

Refer to FIG. 1A, the thermal image auxiliary processing device 110 is configured for auxiliary positioning of cutting tools 104 or grinding tools 106 before and after processing and measurement of the size, angle or flatness of an object (e.g., the raw material 103). The thermal image auxiliary processing device 110 includes a thermal image sensing module 116 and a processing unit 112. The processing unit 112, such as a computer, includes a controller 113 and an input unit 114 for inputting commands. The thermal image sensing module 116 uses a thermal image (such as an infrared image) to synchronously monitor the temperature rise when the raw material is in contact with the tool, and the processing unit 112 can calculate, according to the thermal image MG, the size, angle, and flatness of the object to be measured, or determine whether the tool 104 and the raw material 103 are in contact when a hot spot H1 is generated due to the temperature rise.

Please refer to the positioning measurement process of FIG. 1B, in step S11, a reference part is prepared, such as a reference part or a trimmer, in step S12, a reference positioning point (surface) is established with the reference part, In step S13, the reference positioning point (surface) is configured to position the processing tool (grinding tool) under test. Next, in step S14, according to whether there is a hot spot of temperature rise in the thermal image, a determined positioning point (surface) is obtained. In this way, the positioning measurement of the processing tool (grinding tool) is completed, which facilitates subsequent mass production processing.

Please refer to the wear detection flow in FIG. 10. First, in step S15, a determined positioning point (surface) is established with the reference part, and in step S16, a tracking offset cutting process for the determined positioning point (surface) is performed through the specified processing commands. In step S17, according to a hot spot of temperature rise in the thermal image, it is determined whether the size of the object (e.g., the workpiece) meets the tolerance standard. If it does not meet the tolerance standard, in step S18, the wear value needs to be adjusted, and a rework or correct processing is performed. If it meets the tolerance standard, the process continues to the mass production processing.

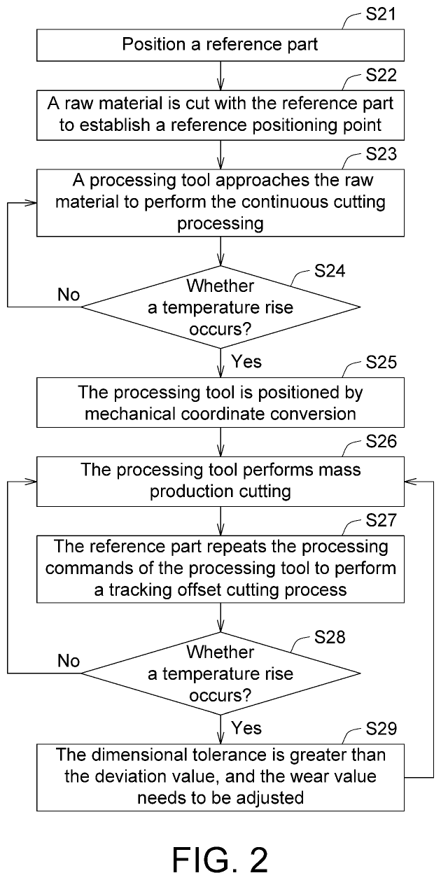

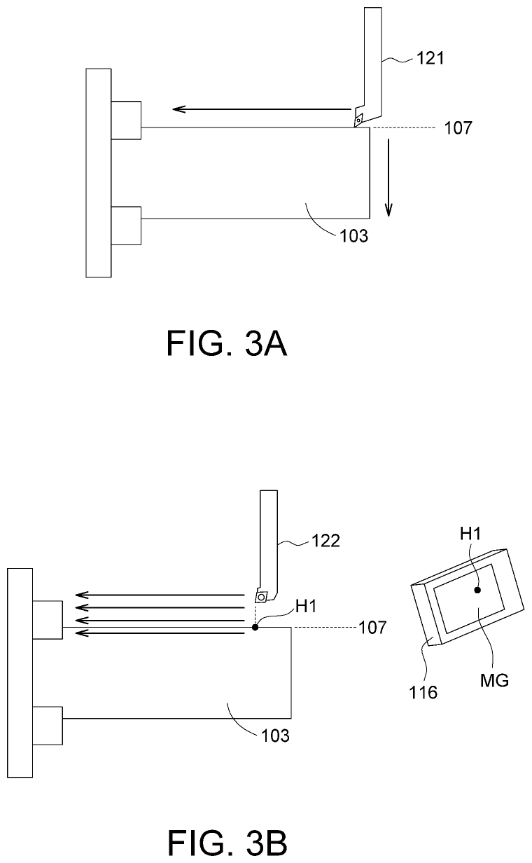

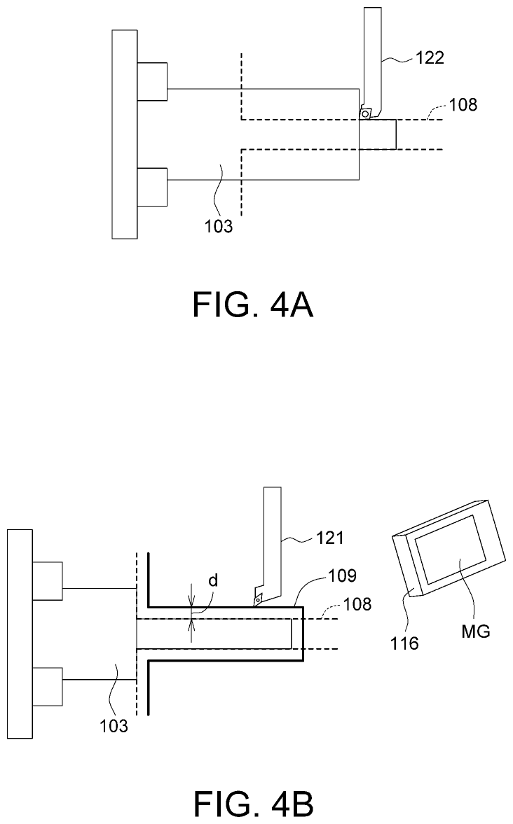

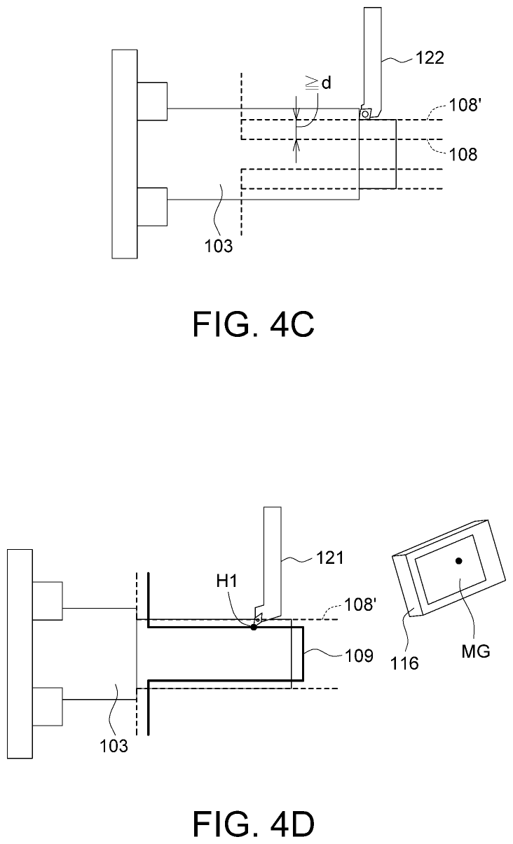

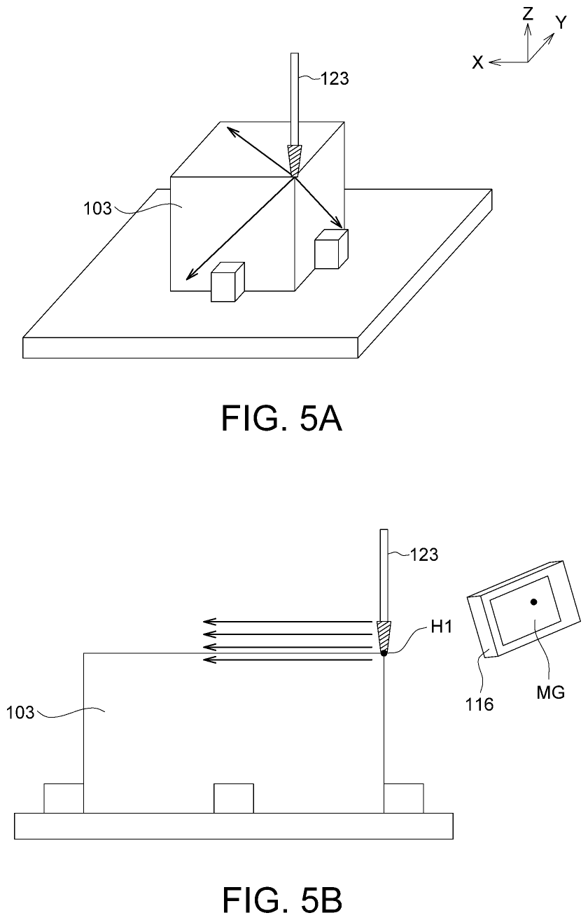

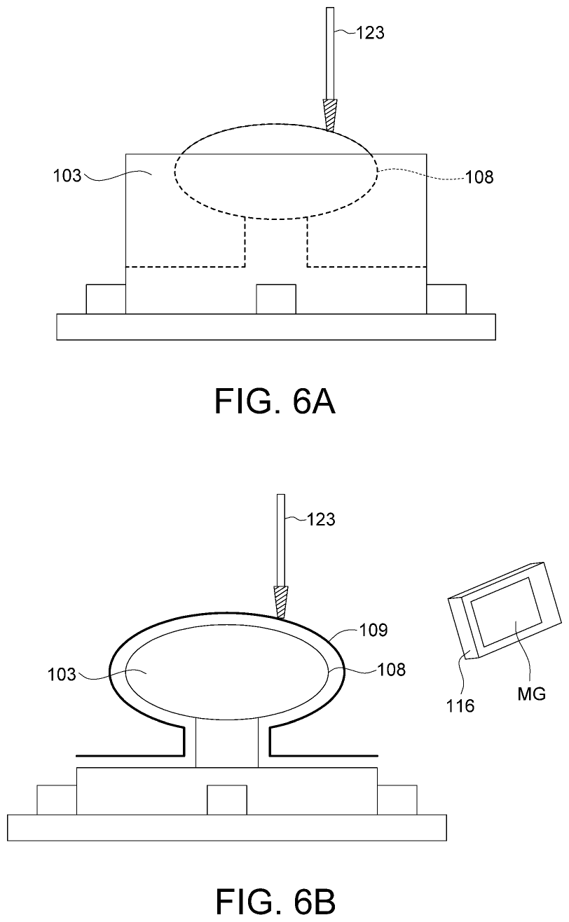

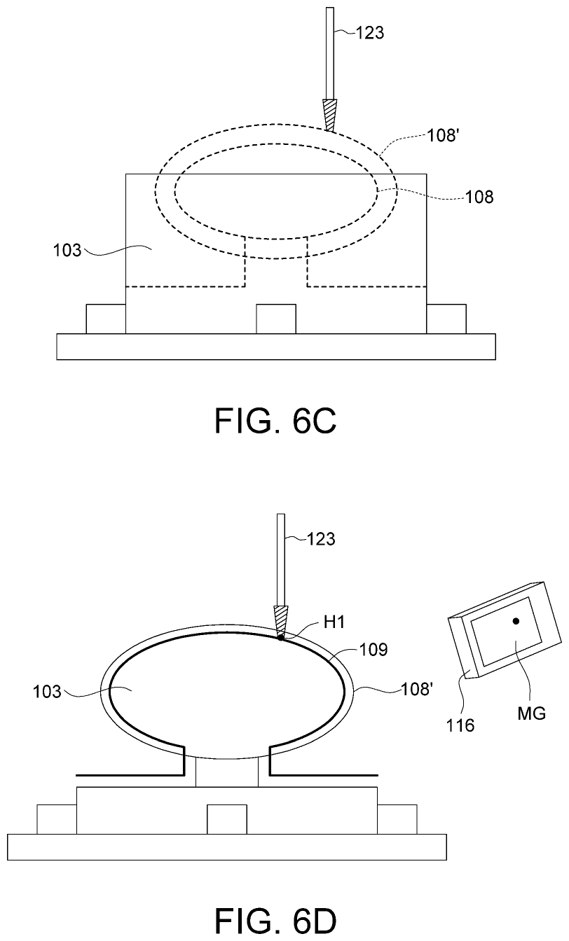

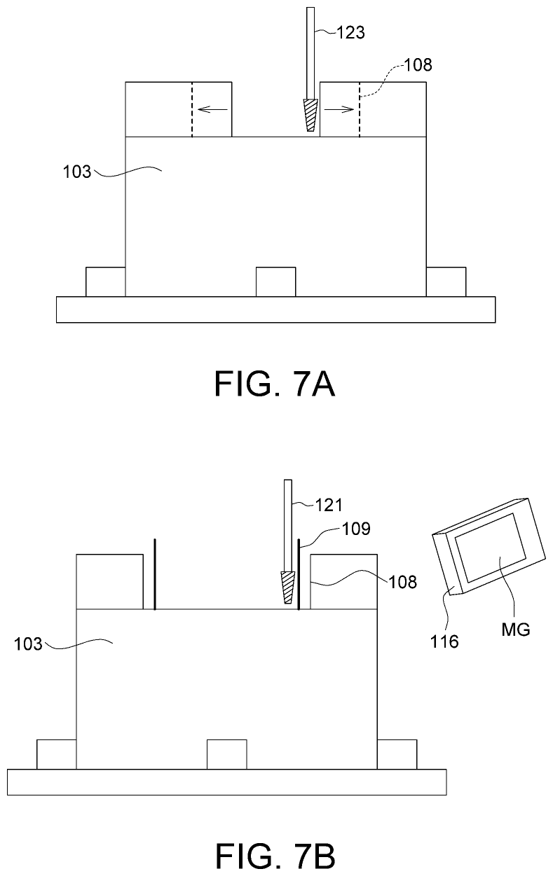

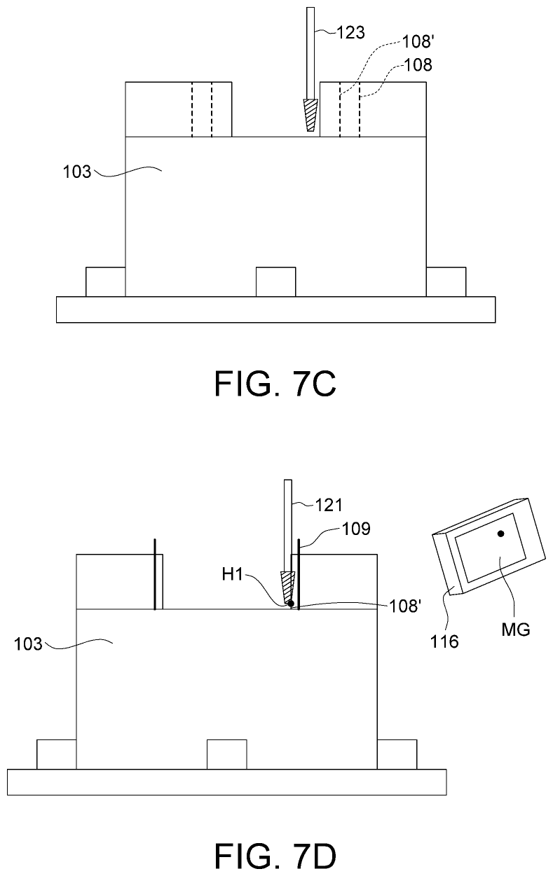

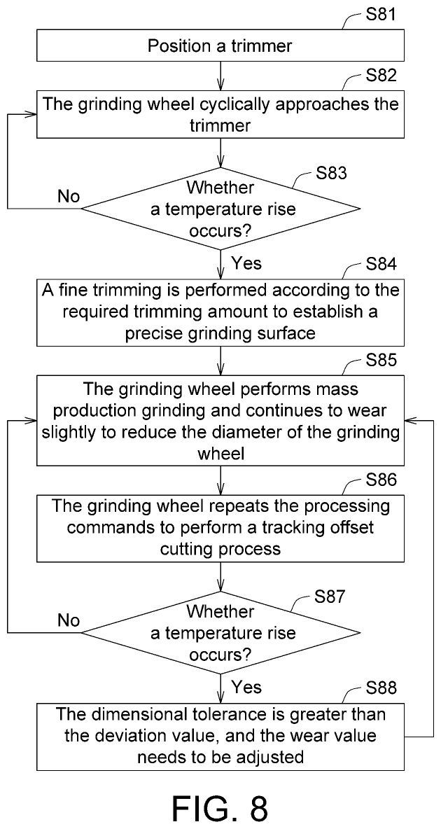

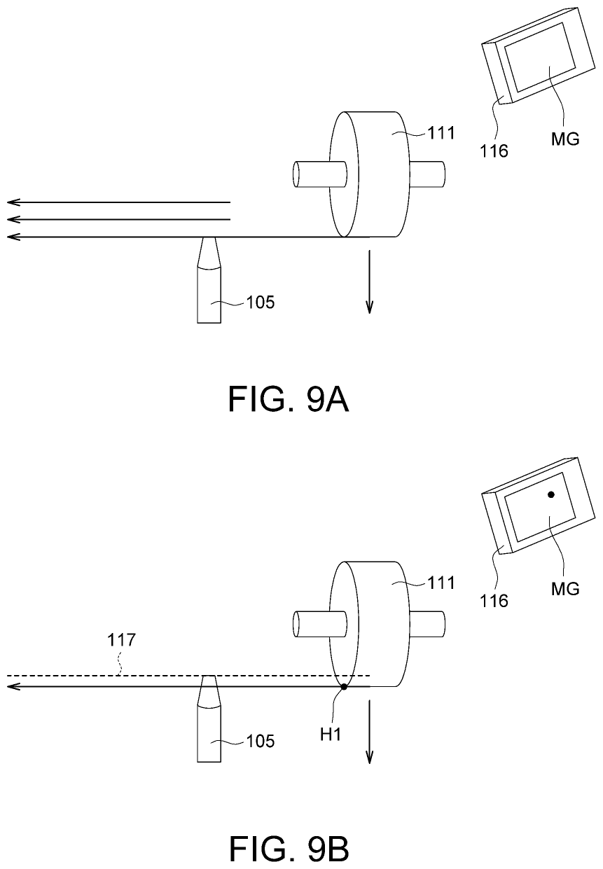

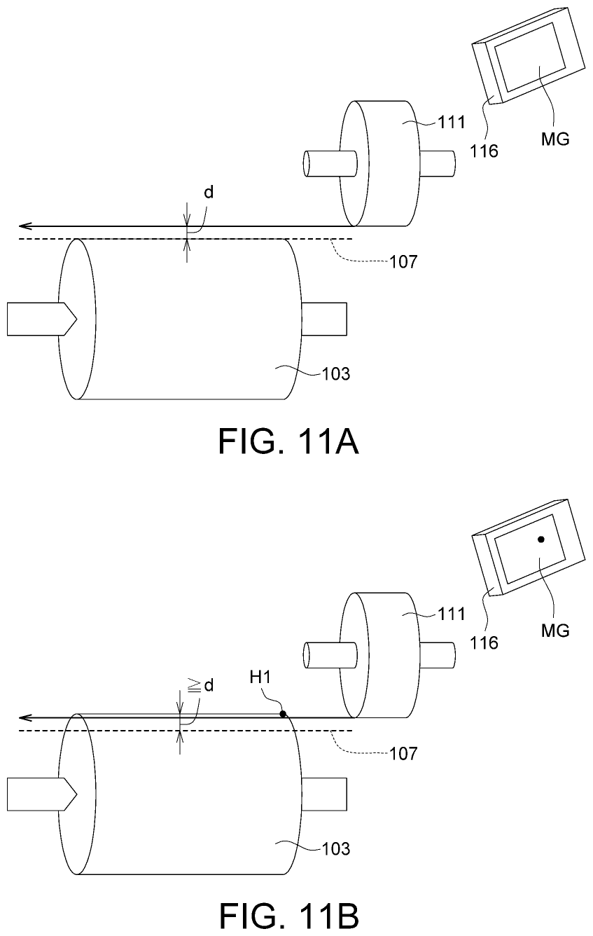

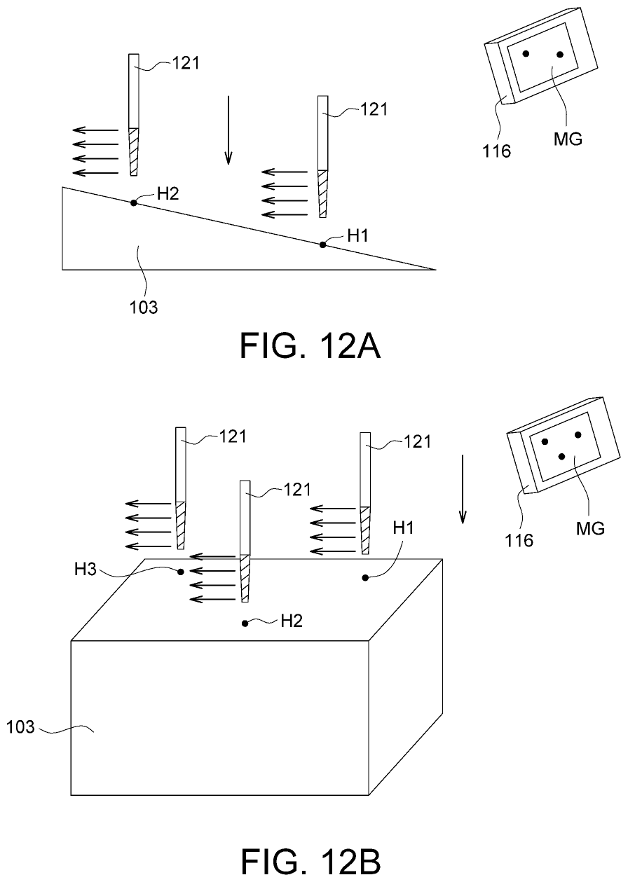

The following is a detailed description of the thermal image auxiliary processing method for different embodiments. FIG. 2 shows a flow chart of the thermal image auxiliary processing method for positioning and wear detection of the cutting tool 104 according to an embodiment of the present disclosure; FIGS. 3A and 3B show an example operation of the thermal image auxiliary processing method used in the positioning of the cutting tool 104 (e.g., lathe tool) in FIG. 2; FIGS. 4A to 4D show two example operation diagrams of the thermal image auxiliary processing method for wear detection of the cutting tool 104 (e.g., lathe tool) in FIG. 2; FIGS. 5A and 5B show another example of the thermal image auxiliary processing method for the positioning of the cutting tool 104 (e.g., drill or milling tool) in FIG. 2; FIGS. 6A to 6D respectively show another two example operation diagrams of the thermal image auxiliary processing method for cutting tool 104 (e.g., milling tool) wear detection in FIG. 2; FIGS. 7A to 7D respectively show another example operation diagram of the thermal image auxiliary processing method for the cutting tool 104 (e.g., drill or milling tool) wear detection in FIG. 2; FIG. 8 shows another operation diagram of the thermal image auxiliary processing method for the positioning and wear detection of a grinding tool 106 (e.g., grinding wheel); FIGS. 9A and 9B show an example operation diagram of the thermal image auxiliary processing method for the positioning of the grinding tool 106 (e.g., a grinding wheel) in FIG. 8; FIGS. 10A and 10B shows another example operation diagram of the thermal image auxiliary processing method for the positioning of the grinding tool 106 (e.g., a polygonal grinding wheel) in FIG. 8; FIGS. 11A and 11B show an example operation diagram of the thermal image auxiliary processing method for wear detection of the grinding tool 106 (e.g., a grinding wheel) in FIG. 8; and FIGS. 12A and 12B show two example operation diagrams of a thermal image auxiliary processing method for angle measurement and planar measurement.

Please refer to FIGS. 2, 3A and 3B. First, in step S21, the reference part 121 is positioned. In step S22, a raw material 103 is cut with the reference part 121 to establish a reference positioning point (surface) 107, wherein the coordinates of the tip of the reference part 120 are known. In step S23, a processing tool 122 is configured to approach the raw material 103 to perform the continuous cutting processing, but the raw material 103 has not been cut. In step S24, the thermal image sensing module 106 is configured to synchronously monitor whether thermal temperature rise occurs. If the hot spot H1 of the temperature rise is monitored, it means that the processing tool 122 has just contacted the raw material 103, that is, it has reached the reference positioning point (surface) 107. In step S25, the controller 113 performs mechanical coordinate conversion to complete the positioning of the processing tool 122 (that is, the coordinates of a determined positioning point is obtained). If the hot spot H1 of temperature rise is not detected, go back to step S23 and continue to approach the raw material 103. The so-called mechanical coordinate conversion performed by the controller 113 refers to the calculation of the position or the coordinates reached by the processing tool 122 after multiple cycles of feeding and cutting processing.

Please refer to FIG. 3A, the coordinate position of the tip of the above-mentioned reference part 121 is known, the reference part 121 does not participate in the subsequent mass production cutting after positioning, and since the reference part 121 is only configured for positioning without wear for long-term use, there is no need to go through the process of positioning the reference part 121 every time. In addition, when the reference part 121 cuts the raw material 103, the processing unit 112 in FIG. 1 can determine the position and the size of the raw material 103 through numerical analysis.

Please refer to FIG. 3B, since the coordinate position of the tip of the processing tool 122 is unknown, the reference part 121 first establishes the position of the reference positioning point (surface) 107. Next, the processing tool 122 approaches the raw material 103 until it just contacts the raw material 103 to cut (e.g., 1 μm cutting thickness or more, depending on the precision of the feed mechanism). At the same time, the thermal image MG instantly displays the hot spot H1 generated by temperature rise when the processing tool 122 cuts the raw material 103, for the controller 113 of the processing unit 112 to perform the mechanical coordinate conversion 122 for the coordinates of tool. For example, the coordinates of the tip of the processing tool 122 is approximately equal to the reference positioning point (surface) 107 established by the reference tool 121 minus the distance that the processing tool 122 successively approaches the reference positioning point (surface) 107 in the same direction. The minimum approach distance is determined by the minimum feed accuracy of the machine tool 100 (which may be 1 μm or greater), but the present disclosure is not limited thereto.

After the above-mentioned positioning of the processing tool 122 is completed, the wear detection of the processing tool 122 may be further performed. Please refer to FIG. 2. First, in step S26, the processing tool 122 starts to perform mass production cutting. At this time, the processing tool 122 continues to suffer a small amount of wear to reduce the length, so that the processing tool 122 has a wear amount after cutting (that is, the initial size of the processing tool 122 minus the cutting remaining size). In step S27, after the mass production cutting is completed, the reference part 121 repeats the last processing commands of the processing tool 122 to perform a tracking offset cutting process. For example, the reference part 121 is moved and tracks along the raw material 103 and offset relative to the cutting surface of the raw material 103 by a tolerance or a predetermined deviation value. In step S28, the thermal image MG is synchronously monitored to determine whether there is a hot spot H1 of temperature rise on the cutting surface. If the hot spot H1 of the temperature rise is monitored, in step S29, it is determined that the wear amount of the processing tool 122 is greater than the tolerance (or the predetermined deviation value), which means that the dimensional tolerance of the raw material 103 is greater than the deviation value, and the wear value needs to be adjusted (as shown in step S18 in FIG. 10) to rework or correct the raw material 103 (return to Step S26). If hot spot H1 of the temperature rise is not monitored, it is determined that the wear amount of the processing tool 122 is less than the tolerance (or the predetermined deviation value), then the process goes back to step S26 to continue the next mass production cutting process. The tolerance is, for example, the differences that the processing personnel allow for the finished dimensions of the qualified raw material 103.

Please refer to FIGS. 4A and 4B, the wear amount of the processing tool 122 less than the tolerance d is shown in an embodiment. In this embodiment, the processing tool 122 is gradually worn out due to multiple cycles of processing, so that the actual cutting amount of the processing tool 122 is gradually smaller than the expected cutting amount. Therefore, it is necessary to perform wear detection of the processing tool 122 to confirm whether the wear amount is within the allowable tolerance (1 μm or more). As shown in FIG. 4A, when the wear amount of the processing tool 122 is still small, the processing tool 122 performs cutting at the expected processing position 108, and then, as shown in FIG. 4B, the reference part 121 repeats the last processing command of the processing tool 122 and moves along the raw material 103 and offset outward by a tolerance d, so that the cutting position 109 of the reference part 121 deviates from the expected processing position 108 and thus does not contact the surface of the raw material 103. At the same time, there is no thermal temperature rise, so the thermal image MG does not show the hot spot H1 of temperature rise, which means that the wear amount of the processing tool 122 is smaller than the tolerance d.

Please refer to FIGS. 4C and 4D, the wear amount of the processing tool 122 greater than the tolerance d is shown in an embodiment. As shown in FIG. 4C, when the wear amount of the processing tool 122 is too large, the processing tool 122 does not locate at the expected processing position 108, so that the actual processing position 108′ deviates from the expected processing position 108 (i.e., the wear amount is greater than or equal to the tolerance d), then, as shown in FIG. 4D, the reference part 121 repeats the last processing command of the processing tool 122 to move along the raw material 103 and offset outward by a tolerance d. However, since the cutting amount of the processing tool 122 is insufficient, the reference part 121 still contacts the surface of the raw material 103, and the hot spot H1 of temperature rise is displayed in the thermal image MG, indicating that the wear amount of the processing tool 122 is greater than the tolerance d.

As can be seen from the above description, when the thermal image MG shows the hot spot H1 of temperature rise, it means that the wear amount of the processing tool 122 exceeds the allowable tolerance range. Meanwhile, the processing tool 122 can be corrected for wear. The wear correction can be automatically implemented by the positioning measurement in steps S22 to S25 of FIG. 2.

As shown in FIG. 2, in step S29, when the dimensional tolerance is greater than the deviation value, referring to steps S22 to S25, the wear correction of the processing tool 122 is performed. A similar method includes the following steps, in step S22, cutting the raw material 103 with the reference part 121 to establish a new reference positioning point. In step S23, the processing tool 122 cyclically approaches the raw material 103 until the raw material 103 is cut, and the cutting process is performed at a new reference positioning point. In step S24, whether there is a hot spot H1 of temperature rise is synchronously monitored from the thermal image MG. If the hot spot H1 of temperature rise is monitored, in step S25, the processing tool 122 is positioned by mechanical coordinate conversion (i.e., a determined positioning position is obtained), and the wear correction of the processing tool 122 is completed.

Please refer to FIGS. 5A and 5B, it is similar to the thermal image auxiliary processing method of FIGS. 3A and 3B, both are configured for the positioning of the cutting tool 104, the same or corresponding description will not be repeated, the difference is that the processing tool 123 of the present embodiment is a drill tool or a milling tool. The drill or milling tool can be driven in the XY plane, the XZ plane or the YZ plane until it touches and cut the surface of the raw material 103 (e.g., 1 μm milling thickness or more). At the same time, the thermal image MG instantly displays the hot spot H1 of temperature rise when the processing tool 123 contacts the raw material 103, so that the processing unit 112 can perform mechanical coordinate conversion to complete the positioning of the processing tool 123 (i.e., a determined positioning position is obtained).

After the above-mentioned positioning of the processing tool 123 is completed, when the processing tool 123 has been used for a period of time or a number of times in mass production, the wear detection of the processing tool 123 may be further performed. Please refer to FIGS. 6A to 6D and FIGS. 7A to 7D, which are similar to the thermal image auxiliary processing method of FIGS. 4A to 4D, both of which are configured for wear detection of the processing tool 123, and the same or corresponding description will not be repeated here. The difference in that the processing tool 123 for wear detection in present embodiment is a drill tool or a milling tool. The drill or milling tool is gradually worn out due to multiple cycles of processing (such as tool length or tool diameter wear), so that the actual cutting amount is gradually less than the expected cutting amount. Therefore, it is necessary to perform wear detection of the processing tool 123 to confirm whether the wear amount is within the allowable tolerance (1 μm or more). For example, as shown in FIGS. 6A and 7A, when the wear amount of the processing tool 123 is still small, the processing tool 123 performs milling at the expected processing position, and then as shown in FIGS. 6B and 7B, the reference part 121 repeats the final processing command of the processing tool 123 and move along the raw material 103 and offset outward by a tolerance, so that the reference part 121 does not contact the surface of the raw material 103. At this time, the thermal image MG does not show the hot spot H1 of temperature rise, which means that the wear amount of the processing tool 123 is less than the tolerance. In addition, as shown in FIGS. 6C and 7C, when the wear amount of the processing tool 123 is large, the processing tool 123 does not locate at the expected processing position, so that the actual processing position 108′ deviates from the expected processing position 108. Then, as shown in FIGS. 6D and 7D, the reference part 121 repeats the last processing command of the processing tool 123 and moves along the raw material 103 and has an offset outward by a tolerance, however, because the cutting amount of the processing tool 123 is insufficient, the reference part 121 will touch the surface of the raw material 103, and the thermal image MG displays a hot spot H1 of temperature rise, which means that the wear amount of the processing tool 123 is greater than the tolerance.

In addition, similar to the lathe tool, the size correction of the drill tool or the milling tool can be automatically implemented by the positioning measurement in the steps S22 to S25 of FIG. 2, which will not be repeated here.

A thermal image auxiliary processing method for positioning and wear detection of a grinding tool 106 (e.g., a grinding wheel) is described as follows. Referring to FIG. 8, in step S81, a trimmer 105 is positioned. The coordinates of a tip of the trimmer 105 are known, and the tip of the trimmer 105 is configured as a reference positioning point. In step S82, the grinding wheel 111 cyclically approaches the trimmer 105 until it contacts the trimmer 105. In step S83, a thermal image MG is synchronously monitored to determine whether a thermal temperature rise occurs. If the hot spot H1 of temperature rise is monitored, it means that the grinding wheel 111 has just contacted the trimmer 105. Then, in step S84, a fine trimming is performed according to the required trimming amount to establish a precise grinding surface 117 (i.e., a determined positioning surface is obtained). If the hot spot H1 of temperature rise is not monitored, the process returns to step S82, and grinding wheel 111 continuously approaches the trimmer 105.

Please refer to FIG. 9A, the trimmer 105 has been positioned, and since the hardness and strength of the trimmer 105 are much higher than those of the grinding wheel 111, the trimmer 105 can be used for a long time without wear and does not need to go through the process of positioning the trimmer 105 every time. In addition, when the trimmer 105 trims the grinding wheel 111, the processing unit 112 can determine the position of the precise grinding surface 117 of the grinding wheel 111 through numerical analysis of the controller.

Please also refer to FIG. 9B, based on the tip of the trimmer 105, the surface of the grinding wheel 111 is finely trimmed to establish a precise grinding surface 117 (that is, the determined positioning surface), so that the grinding wheel 111 can return to original grinding performance. At this time, the thermal image MG instantly displays the hot spot H1 of temperature rise generated by the grinding wheel 111 for the processing unit 112 to perform mechanical coordinate conversion to complete the positioning of the grinding wheel 111 (i.e., a determined positioning position is obtained). For example, the positioning of the grinding wheel 111 is calculated by the coordinates of the tip of the trimmer and the coordinates of the grinding wheel 111 moved by the controller.

In addition, please refer to FIGS. 10A and 10B, taken a polygonal grinding wheel as an example, in step S82, the grinding wheel 111 cyclically approaches the trimmer 105 until it contacts the trimmer 105. At this time, the side surface of the grinding wheel 111 contacts with the side surface of the trimmer 105, and then in step S84, the surface of the grinding wheel is finely trimmed according to the required trimming amount to establish a precise grinding surface 117.

After the positioning of the grinding tool 106 is completed, the wear detection of the grinding tool 106 can be further performed. Please refer to FIG. 8, in step S85, the grinding wheel 111 performs mass production grinding. At this time, the grinding wheel 111 continues to wear slightly to reduce the diameter of the grinding wheel 111, so that the grinding wheel 111 has a wear amount after grinding (that is, the initial grinding wheel size minus the remaining size after grinding). In step S86, the grinding wheel 111 repeats the processing command to perform a tracking offset cutting process. For example, the grinding wheel 111 moves along the raw material 103 and has an offset outward by a tolerance d or a predetermined deviation value relative to a grinding surface of the raw material 103. In step S87, the thermal image MG is synchronously monitored to determine whether there is a thermal temperature rise on the grinding surface. If the hot spot H1 of temperature rise is monitored, in step S88, it is determined that the wear amount of the grinding wheel 111 is greater than the tolerance d (or the predetermined deviation value), which means that the dimensional tolerance of the raw material is greater than the deviation value, and the wear value needs to be adjusted (similar to the step S18 of FIG. 10) to rework or correct the workpiece to be processed (return to step S85). If the hot spot H1 of temperature rise is not monitored, it is determined that the wear amount of the grinding wheel 111 is less than the tolerance d (or a predetermined deviation value), and then the process returns to step S85 to continue grinding.

Please refer to FIGS. 11A and 11B, the wear amount of the grinding wheel 111 less than and greater than or equal to the tolerance respectively described in two embodiments. In these embodiments, the grinding wheel 111 is gradually worn out due to multiple cycles of processing, so that the actual cutting amount of the grinding wheel 111 is gradually smaller than the expected cutting amount. Therefore, it is necessary to perform the wear detection of the grinding wheel 111 to confirm whether the wear amount of the grinding wheel 111 is within the allowable tolerance. First, the trimmer 105 is configured to finely trim the grinding wheel 111, and the coordinates of grinding wheel 111 moved by the controller are obtained to establish the reference positioning surface 107 on the grinding wheel surface. As shown in FIG. 11A, when the wear amount of the grinding wheel 111 is small, the grinding wheel 111 moves along the raw material 103 and has an offset outward by a tolerance d, so that the grinding wheel 111 does not contact the surface of the raw material 103. At this time, the thermal image MG does not show the hot spot H1 of temperature rise, which means that the wear amount of the grinding wheel 111 is less than the tolerance d. As shown in FIG. 11B, when the wear amount of the grinding wheel 111 is too large, even though the grinding wheel 111 moves along the raw material 103 and has an offset outward by a tolerance d, the grinding wheel 111 will still contact the surface of the raw material 103, and the thermal image MG displays a hot spot H1 of temperature rise, which means that the wear amount of the grinding wheel 111 is greater than the tolerance.

As can be seen from the above description, when the thermal image MG displays the hot spot H1 of temperature rise, it means that the wear amount of the grinding wheel 111 is not within the allowable tolerance range, and at this time, the grinding wheel 111 can be corrected for wear. The size correction can be automatically implemented by the steps S82 to S84 of FIG. 8. The wear correction of the grinding wheel 111 is generally similar to that described in FIG. 8, including: trimming the grinding wheel surface with the trimmer 105, and synchronously monitoring the thermal temperature rise of the grinding wheel surface with the thermal image MG, and then, according to the thermal image MG, a new precision grinding surface (i.e., the determined positioning surface) is established on the surface of the grinding wheel to perform wear correction of the grinding wheel 111.

Please refer to FIGS. 12A and 12B, in addition to the auxiliary positioning and wear detection of the cutting tool 104 and the grinding tool 106 of the above-mentioned embodiments, the thermal image auxiliary processing method can also be used for angle measurement and planar measurement of the workpiece (such as the raw material 103), referring to the positioning measurement process described in FIG. 1B. In FIG. 12A, a positioned reference part 121, a milling tool or a grinding tool is configured to cyclically approach the surface of the raw material 103, and the thermal image MG is synchronously monitored to determine the thermal temperature rise of the surface of the raw material 103 to obtain a first hot spot H1 of temperature rise. The controller converts the mechanical coordinates to obtain a first position coordinate information (i.e., a first positioning point or a first positioning surface). In addition, a positioned reference part 121, a milling tool or a grinding tool is configured to cyclically approach the surface of the raw material 103, and the thermal image MG is configured to monitor the thermal temperature rise of the surface of the raw material 103 synchronously, so as to obtain a second hot spot H2 of temperature rise. The controller converts the mechanical coordinates to obtain a second position coordinate information (i.e., a second positioning point or a second positioning surface). The first positioning point and the second positioning point are separated by a predetermined distance. According to the distance and height difference between the first positioning point and the second positioning point, the slope and inclination angle of the surface of the raw material 103 are calculated to complete the angle measurement.

Similar to the above-mentioned method, in FIG. 12B, the thermal image MG is synchronously monitored to find the thermal temperature rise of the surface of the raw material 103, so as to obtain at least three hot spots H1 to H3 of temperature rise (that is, at least three positioning points or positioning surfaces). According to the plane and height difference formed by at least three positioning points, the flatness of the surface of the raw material 103 is calculated to complete the planar measurement.

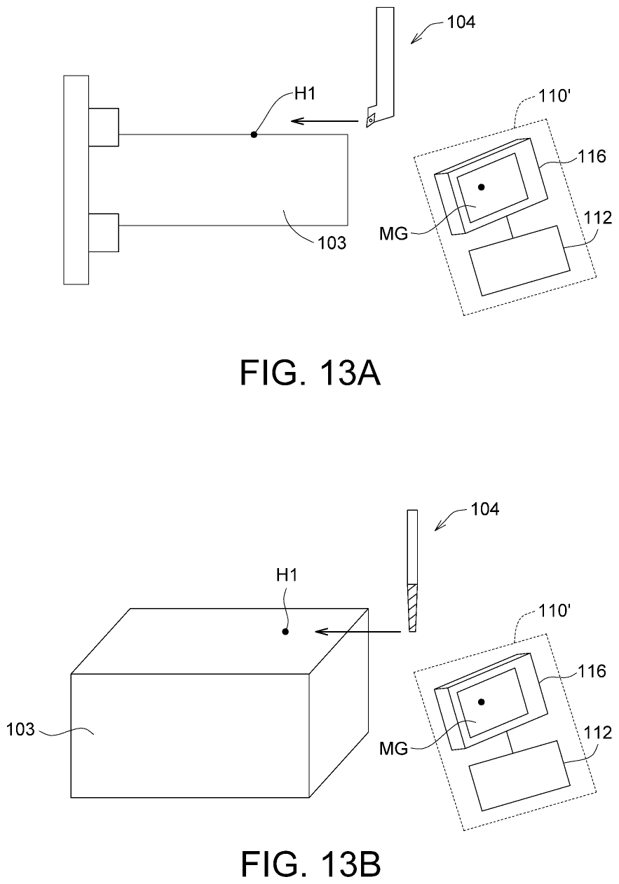

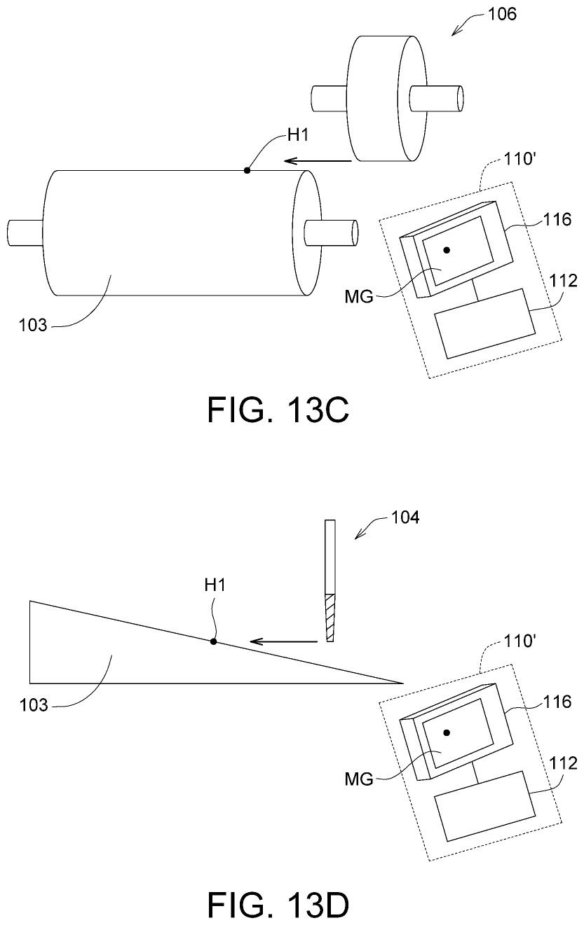

Please refer to FIGS. 13A to 13D, exemplary operational diagrams of a thermal image auxiliary positioning method for alignment of a cutting tool or a grinding tool are provided, respectively. FIG. 13A shows a thermal image auxiliary positioning method for a cutting tool (such as a latch tool) similar to FIG. 3B, and FIG. 13B shows a thermal image auxiliary positioning method for a tool (such as a drill tool or a milling tool) similar to FIG. 5B. FIG. 13C shows a thermal image auxiliary positioning method for a grinding tool (such as a grinding wheel) similar to FIG. 11B, and FIG. 13D shows a thermal image auxiliary positioning method for a tool (such as a drill tool or a milling tool) similar to FIG. 12A. In an embodiment, the thermal image auxiliary positioning device 110′ includes a thermal image sensing module 116 and a processing unit 112. The thermal image sensing module 116 can simultaneously monitor the thermal temperature rise of a cutting tool 104 or a grinding tool 106 in contact with the raw material (or the workpiece to be processed) 103. The processing unit 112 may, according to a thermal image MG, monitor at least one hot spot H1 of temperature rise of the cutting tool 104 or the grinding tool 106, and the processing unit 112 may send a prompt signal. The processing unit 112 may include a processor and a firmware or a controller for executing application programs, the processing unit 112 can be a computer or a mobile communication device, for example.

In an embodiment, the prompt signal may be at least one of a sound signal from a horn or a buzzer, a light signal from a flash or a light source such as an LED, and an image signal from a monitor. Through the above positioning method, the operator can manually operate the cutting tool 104 or the grinding tool 106 to move along a predetermined direction (e.g., cutting direction), so that the tip of tool or the grinding surface gradually approaches the raw material (or the workpiece to be processed) 103. When the tip of tool touches the raw material (or the workpiece to be processed) 103, the raw material 103 is heated by the cutting of the tip of tool or the grinding surface, and the thermal image sensing module 116 detects the hot spot H1 of temperature rise, the processing unit 112 sends a prompt signal (such as flashing light, buzzer, images, etc.) to the operator, so that the operator knows that the tool setting in the predetermined direction (such as the cutting direction) has been completed.

The error of the above-mentioned tool setting using thermal image auxiliary positioning can be reduced to about 1 μm, which is less than the error of manual tool setting (about 10 μm), and the tool setting error in the embodiment has a high repeatability rate, and thus the reliance on the operator's visual judgment can be significantly reduced.

The thermal image auxiliary processing device and the auxiliary processing method thereof according to the above embodiments of the present disclosure can be used for auxiliary positioning, wear detection of a cutting tool or a grinding tool, as well as for the measurement of the size, angle or flatness of the object to be measured. Therefore, the present disclosure can avoid problems such as increased downtime of equipment and recalibrated errors caused by manual and visual measurement. At the same time, the thermal image measurement technology can replace traditional size measurement and general optical image recognition and monitoring, it is more convenient in operation, the cost is low, and it is not easily affected by environmental factors (including light and surface material, etc.), and the installation and measurement of the thermal image sensor module is relatively easy, does not require accurate calibration, and the measurement precision depends on the smallest effective moving distance of the machine (processing precision can be 1 μm or more), so it can meet the requirements of the processing precision of the machine tool.

It will be apparent to those skilled in the art that various modifications and variations can be made to the disclosed embodiments. It is expected that the specification and examples be considered as exemplary only, with a true scope of the disclosure being indicated by the following claims and their equivalents.

What is claimed is:

1. A thermal image auxiliary processing method, comprising:
establishing a reference positioning point or surface with a reference part;
positioning a processing tool or a grinding wheel with the reference positioning point or surface; and
according to a hot spot of temperature rise in a thermal image, a determined positioning point or surface of the processing tool or the grinding wheel is obtained.

2. The thermal image auxiliary processing method according to claim 1, for positioning the processing tool, wherein:
using a reference tool as the reference part to establish the reference positioning point on a raw material;
cyclically approaching the raw material with the processing tool, and synchronously monitoring the thermal temperature rise of the processing tool; and
when the hot spot of temperature rise is monitored, the determined positioning point is positioned by converting mechanical coordinates.

3. The thermal image auxiliary processing method according to claim 2, further comprising:
taking a tip of the reference part as the determined positioning point;
performing a tracking offset cutting process on the raw material with the determined positioning point and a processing command;
monitoring the thermal temperature rise of the reference part to determine whether a size of the raw material complies with a tolerance standard; and
based on the determination, it is determined whether or not to correct the raw material.

4. The thermal image auxiliary processing method according to claim 3, further comprising:
performing a wear detection of the processing tool, comprising:
performing a tracking movement on the raw material with the reference part and the processing command, and having an offset by a distance relative to a cutting surface of the raw material;
simultaneously monitoring the thermal temperature rise of the cutting surface;
when the hot spot of temperature rise is not monitored, it is determined that a wear amount of the processing tool is less than the tolerance standard; and
when the hot spot of temperature rise is monitored, it is determined that the wear amount of the processing tool is greater than the tolerance standard.

5. The thermal image auxiliary processing method according to claim 4, wherein when it is determined that the wear amount of the processing tool is greater than the tolerance standard, the method further comprises:
the processing tool is repositioned by mechanical coordinate conversion to complete the wear correction of the processing tool.

6. The thermal image auxiliary processing method according to claim 4, wherein the tolerance is a difference allowed by a processing personnel for the size of a qualified finished product.

7. The thermal image auxiliary processing method according to claim 1, for positioning the grinding wheel, wherein:
using a tip of a trimmer as the reference positioning point, trimming the surface of the grinding wheel, and synchronously monitoring the thermal temperature rise of the grinding wheel; and
when the hot spot of temperature rise is monitored, the determined positioning surface is positioned by converting the mechanical coordinates.

8. The thermal image auxiliary processing method according to claim 7, further comprising performing wear detection of the grinding wheel, comprising:
performing a tracking movement with the grinding wheel on a raw material and having an offset by a distance relative to a grinding surface of the raw material;
simultaneously monitoring the thermal temperature rise of the grinding surface;
when the hot spot of temperature rise is not monitored, it is determined that the wear amount of the grinding wheel is less than a tolerance standard; and
when the hot spot of temperature rise is monitored, it is determined that the wear amount of the grinding wheel is greater than the tolerance standard.

9. The thermal image auxiliary processing method according to claim 8, wherein when it is determined that the wear amount of the grinding wheel is greater than the tolerance standard, the method further comprises:
taking a tip of the trimmer as the determined positioning point, trimming the grinding wheel surface, and synchronously monitoring the thermal temperature rise of the grinding wheel surface; and
when the hot spot of temperature rise is monitored, the grinding wheel surface is repositioned by mechanical coordinate conversion to complete the wear correction of the grinding wheel.

10. The thermal image auxiliary processing method according to claim 1, used for angle measurement of a raw material, wherein at least two determined positioning points on the raw material are obtained according to at least two hot spots of temperature rise to calculate an inclination angle of the raw material.

11. The thermal image auxiliary processing method according to claim 1, used for planar measurement of a raw material, wherein at least three determined positioning points on the raw material are obtained according to at least three hot spots of temperature rise to calculate a flatness of the raw material.

12. A thermal image auxiliary processing device for positioning an object to be measured, the thermal image auxiliary processing device comprising:
a thermal image sensing module for generating a thermal image to monitor thermal temperature rise of the object to be measured; and
a processing unit comprising a controller, the processing unit determines that the thermal image having a hot spot of temperature rise on the object to be measured, the controller performs mechanical coordinate conversion to obtain a position coordinate information of the object to be measured.

13. The thermal image auxiliary processing device according to claim 12, wherein the object to be measured comprises a cutting tool or a grinding tool, the cutting tool or the grinding tool cyclically approaches a raw material surface and just contacts the raw material surface, the thermal image shows the hot spot of temperature rise, the processing unit obtains the position coordinate information by the mechanical coordinate conversion to position the object to be measured and calculate a size of the object to be measured.

14. The thermal image auxiliary processing device according to claim 12, wherein the processing unit obtains at least two position coordinate information by the mechanical coordinate conversion according to at least two hot spots of temperature rise on the object to be measured, and calculates an inclination angle of the object to be measured.

15. The thermal image auxiliary processing device according to claim 12, wherein the processing unit obtains at least three position coordinate information by the mechanical coordinate conversion according to at least three hot spots of temperature rise on the object to be measured, and calculates a flatness of the object to be measured.

16. A thermal image auxiliary positioning device for positioning a cutting tool or a grinding tool, comprising:
a thermal image sensing module, configured for synchronously monitoring a thermal temperature rise of the cutting tool or the grinding tool; and
a processing unit, configured for sending a prompt signal according to a thermal image when the processing unit monitors at least one hot spot of temperature rise on the cutting tool or the grinding tool.

17. The thermal image auxiliary positioning device according to claim 16, wherein the prompt signal is at least one of a sound signal from a horn or a buzzer, a light signal from a flash or a light source, and an image signal from a monitor.
